(19) United States
(12) Patent Application Publication
(10) Pub. No.: US 2003/0197745 A1
(43) Pub. Date: Oct. 23, 2003

(54) Portable computing device keyboard

(75) Inventor: John J. Daly, Irvine, CA (US)

Correspondence Address: GATEWAY, INC., 14303 GATEWAY PLACE, ATTENTION: MARK WALKER (MAIL DROP SD-21), POWAY, CA, 92064, US

(73) Assignee: Gateway, Inc.

(21) Appl. No.: 10/126,171

(22) Filed: Apr. 19, 2002

(51) Int. Cl. G09G 5/00

(52) U.S. Cl. 345/905

(57) ABSTRACT

In an embodiment, a computing device is provided with a telescoping keyboard. In another embodiment, a computing device is provided with a rotating keyboard. In another embodiment, a computing device is provided with a keyboard mounted on a cover of the computing device. In another embodiment, a computing device is provided with a folding keyboard.

### FIELD

This invention relates generally to portable computing devices and more particularly to a keyboard attached to a portable computing device.

### BACKGROUND

Portable computing and communications devices have quickly become virtually indispensable tools, not only for business purposes, but for personal use as well. Examples of such devices are pocket computers, cellular telephones, and PDAs (Personal Digital Assistants). In order to make these devices convenient to carry, they are quite small, which can make for difficult text entry using a pen, stylus, touchpad, or keypad. Hence, users typically only use these text-entry features for note-taking and scheduling appointments and tasks, and they normally plug in a separate keyboard when wanting to compose e-mail or other text documents. But, a separate keyboard that must be plugged in to the device increases the size and weight that the user must carry and hampers the handy portability of the device. Thus, these problems hamper the usability and convenience of these portable computing and communications devices.

### SUMMARY

In an embodiment, a computing device is provided with a keyboard that telescopes out of a case of the computing device. In another embodiment, a computing device is provided with a keyboard that rotates out from underneath the computing device. In another embodiment, a computing device is provided with a keyboard mounted on a cover of the computing device that rotates down from an indentation in the cover. In another embodiment, a computing device is provided with a folding keyboard having two portions.

### BRIEF DESCRIPTION OF THE DRAWINGS

FIG. 1 depicts a perspective view of a computing device with a telescoping keyboard, according to an embodiment of the invention.

FIG. 2A depicts a top perspective view of a computing device with a rotating keyboard, according to an embodiment of the invention.

FIG. 2B depicts a bottom perspective view of a computing device with a rotating keyboard, according to an embodiment of the invention.

FIG. 3A depicts a perspective view of a computing device with a partially-open keyboard mounted on a cover of the computing device, according to an embodiment of the invention.

FIG. 3B depicts a perspective view of a computing device with an open keyboard mounted on the cover of the computer device, according to an embodiment of the invention.

FIG. 4A depicts a perspective view of a computing device with a partially-open folding keyboard, according to an embodiment of the invention.

FIG. 4B depicts a perspective view of a computing device with an open folding keyboard, according to an embodiment of the invention.

### DETAILED DESCRIPTION

In the following detailed description of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

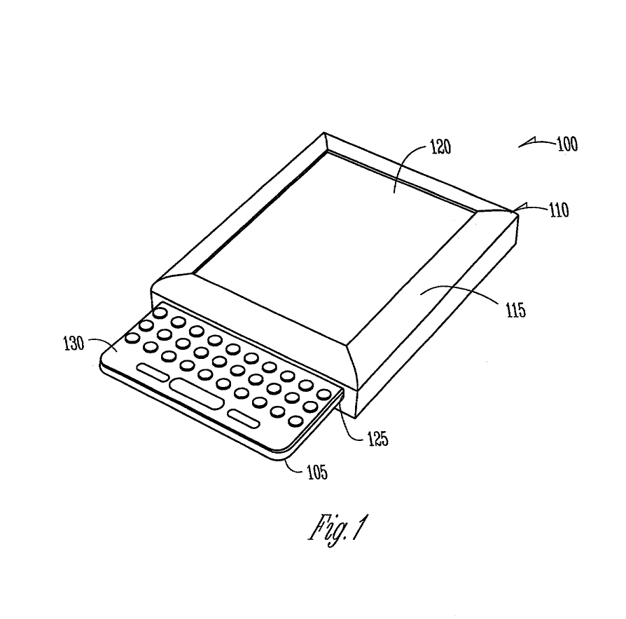

FIG. 1 depicts a perspective view of a computing device 100 with a telescoping keyboard 105, according to an embodiment of the invention. The computing device 100 has a case 110 that includes a top portion 115 including a display screen 120. The computing device 100 may be a PDA (Personal Digital Assistant), a portable telephone, a pocket computer, a laptop computer, or any other appropriate type of computing device. The screen 120 may be a touchscreen, touchpad, LCD (Liquid Crystal Display), flat-panel display, or any other appropriate display screen capable of displaying information. In an embodiment, the screen 120 may accept input from a user via a finger or stylus, but in another embodiment, the screen 120 may not accept input.

The case 110 may have a slot 125 in one side of the case 110 capable of receiving the keyboard 105. The keyboard 105 may move, telescope, or retract between a closed position (not shown) inside the case 110 and an open position (shown in FIG. 1) at least partially outside of the case 110. The keyboard 105 may remain attached to the case 110 when in the open position. The open position may expose the keys or buttons 130 on the top side of the keyboard 105. In an embodiment the keys 130 may be arranged in a QWERTY layout typical of standard typewriters, but in other embodiments any arrangement of keys may be used, and the keys 130 may contain more or fewer keys than a standard typewriter. The keyboard 105 may be electrically connected to another component or components (not shown) within the case 110, such as a bus, a processor, or logic components. In an embodiment, the keyboard 105 may include the battery for the computing device 110. The battery may provide a sturdy mass to enhance the typing experience.

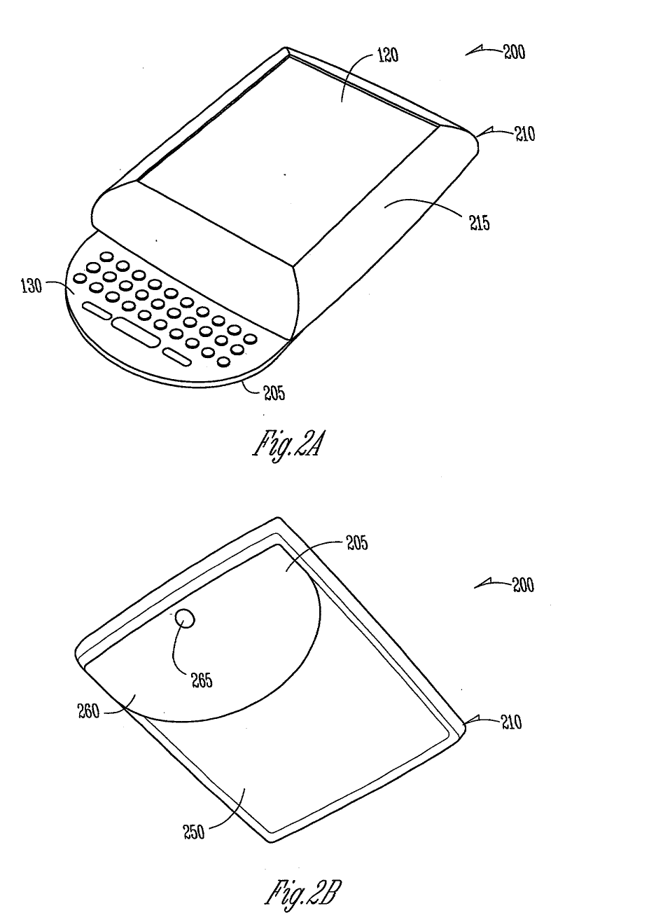

FIG. 2A depicts a top perspective view of a computing device 200 with a rotating keyboard 205, according to an embodiment of the invention. The computing device 200 has a case 210 that includes a top portion 215 including a display screen 120. The computing device 200 may be a PDA (Personal Digital Assistant), a portable telephone, a pocket computer, a laptop computer, or any other appropriate type of computing device.

The keyboard 205 may pivot or rotate between a closed position under the case 210 and an open position at least partially outside of the case 210. FIG. 2A depicts the keyboard 205 in the open position, which may expose the keys or buttons 130 on the top side of the keyboard 205. The keyboard 205 may remain attached to the case 210 when in the open position.

FIG. 2B depicts a bottom perspective view of the computing device 200 with the rotating keyboard 205, according to an embodiment of the invention. FIG. 2B depicts the keyboard 205 in the closed position with the keys 130 (FIG. 2A) hidden from view adjacent to the bottom side 250 of the case 210. The keyboard 205 may be attached to the bottom side 250 of the case 210 via a pin 265. The keyboard 205 may pivot or rotate about the pin 265 between the open (FIG. 2A) and closed (FIG. 2B) positions. The keyboard 205 may be electrically connected to another component or components (not shown) within the case 210, such as a bus, a processor, or other logic components via the pin 265.

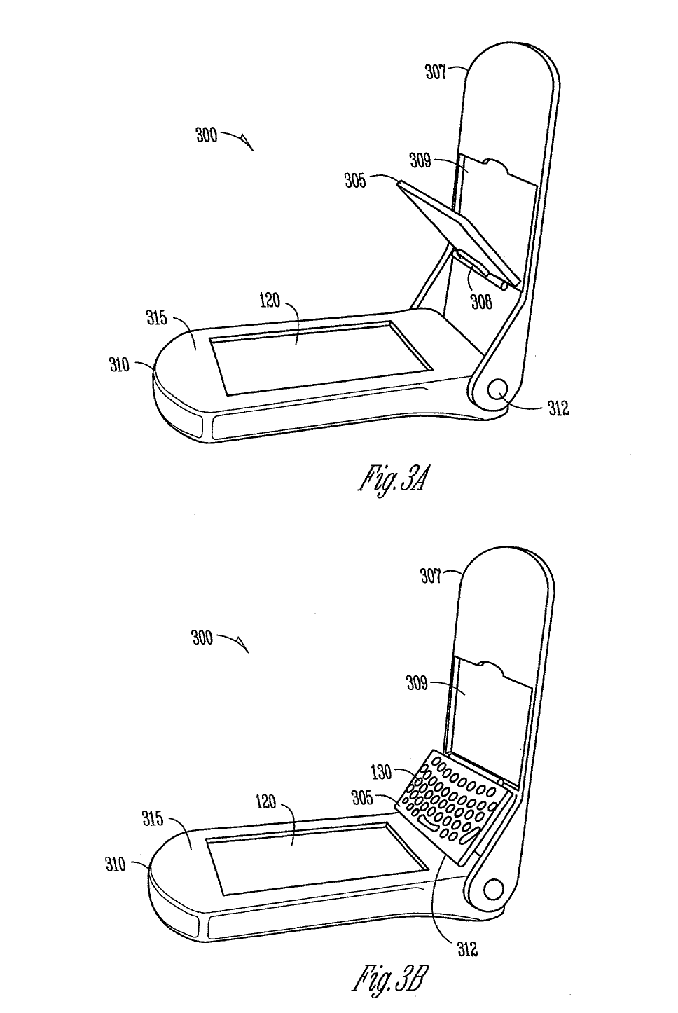

FIG. 3A depicts a perspective view of a computing device 300 with a partially-open keyboard 305 mounted on a cover 307 of the computing device 300, according to an embodiment of the invention. The computing device 300 may be a PDA (Personal Digital Assistant), a portable telephone, a pocket computer, a laptop computer, or any other appropriate type of computing device. The keyboard 305 may be rotatably attached to the cover 307. In an embodiment, the keyboard 305 may be rotatably attached to the cover 307 via a hinge 308, but in another embodiment any appropriate means of rotation may be used. The cover 307 may include an indentation 309 and the keyboard 305 may fit in the indentation 309 when the keyboard is in a closed position.

The cover 307 may be rotatably attached to a case 310 via a pin or pins 312, but in another embodiment a hinge, hinges, or any other means of rotatable attachment may be used. The cover 307 may rotate about the pin 312 from an open position (shown in FIG. 3A) to a closed position (not shown) where the cover 307 is disposed adjacent to the top surface 315 of the case 310 and may cover the display screen 120.

FIG. 3B depicts a perspective view of the computing device 300 with an open keyboard 305 mounted on the cover 307 of the computing device 300, according to an embodiment of the invention. The keyboard 305 may rotate from a closed position (not shown) with the keys 130 on the top portion of the keyboard 305 hidden from view adjacent to the indentation 309, to a partially open position (FIG. 3A), to an open position (FIG. 3B) with an edge 312 of the keyboard 305 resting on the top side 315 of the case 310 and the keys 130 exposed to view. In the open position, the user may hold the computing device 300 and operate the keys 130 with the thumbs or fingers while still having a convenient viewing position for the screen 120.

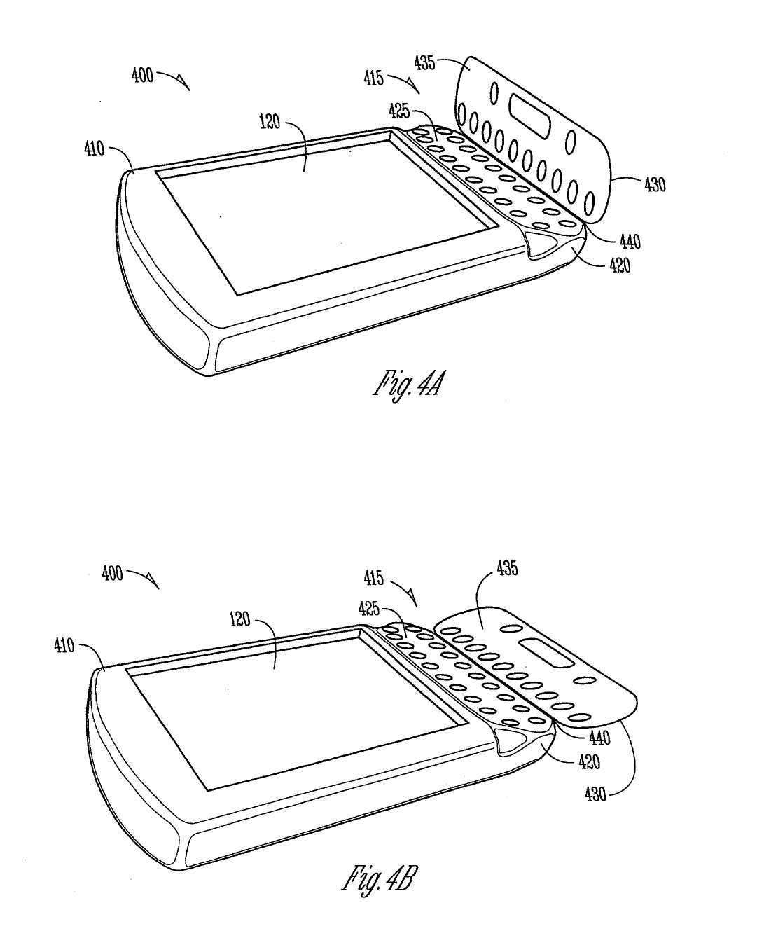

FIG. 4A depicts a perspective view of a computing device 400 with a partially-open folding keyboard 415, according to an embodiment of the invention. The computing device 400 may be a PDA (Personal Digital Assistant), a portable telephone, a pocket computer, a laptop computer, or any other appropriate type of computing device.

The computing device 400 may include a case 410 having a screen 120. The case 410 may be attached to a first portion 420 of the folding keyboard 415, which may include first keys 425. The first portion 420 of the folding keyboard 415 may be attached in a fixed position with respect to the case 410. The first portion 420 of the folding keyboard 415 may be attached to a second portion 430 of the folding keyboard 415, which may include second keys 435. The second portion 430 of the folding keyboard 415 may be rotatably attached to the first portion 420 of the folding keyboard 415 via a hinge 440 or via other appropriate means of attachment. The second portion 430 of the folding keyboard 415 may rotate with respect to the first portion 420 of the folding keyboard 415 from a closed position (not shown) to a partially-open position (shown in FIG. 4A).

When the folding keyboard 415 is in the closed position, the second keys 435 are disposed adjacent to the first keys 425, so that both the first keys 425 and the second keys 435 are hidden from view. The first portion 420 of the folding keyboard 415 and the second portion 430 of the folding keyboard 415 may be approximately the same size and shape, so that when in the closed position, the second portion 430 may cover the first portion 420, but not the screen 120. When in the closed position, the second portion 430 of the folding keyboard 415 may provide a protective cover for the first portion 420 of the folding keyboard 415.

FIG. 4B depicts a perspective view of a computing device 400 with the folding keyboard 415 in an open position, according to an embodiment of the invention. Thus, the second portion 430 of the folding keyboard 415 may rotate about the hinge 440 from a closed position (not shown) to a partially-open position (FIG. 4A) to a closed position (FIG. 4B). In the open position, the two portions (420 and 430) of the folding keyboard 415 may be approximately level, both of their respective keys (425 and 435) may be visible, and the user may type on the keys (425 and 435) while viewing the screen 120 in the case 410.

What is claimed is:

1. A computing device comprising:
a case; and
a keyboard retractable between a closed position inside the case and an open position at least partially outside of the case.

2. The computing device of claim 1, wherein the case further comprises a top portion including a display screen.

3. The computing device of claim 1, wherein the case further comprises a side portion including a slot, wherein the keyboard is disposed within the slot.

4. The computing device of claim 3, wherein keys on the keyboard are hidden from view within the slot in the closed position and exposed to view out of the slot in the open position.

5. A computing device comprising:
a case; and
a keyboard rotatable between a closed position under the case and an open position at least partially outside of the case.

6. The computing device of claim 5, wherein the keyboard attaches to a bottom side of the case via a pin, and wherein the keyboard rotates about the pin.

7. The computing device of claim 5, wherein a plurality of keys on a top of the keyboard are hidden in the closed position and exposed in the open position.

8. The computing device of claim 7, wherein the plurality of keys are disposed adjacent to a bottom side of the case in the closed position.

9. The computing device of claim 5, wherein the case further comprises a top portion including a display screen.

10. A computing device comprising:
a case;
a cover rotatably attached to the case, wherein the cover includes an indentation; and
a keyboard rotatably attached to the cover, wherein the keyboard is disposed in the indentation when the keyboard is in a closed position.

11. The computing device of claim 10, wherein the case further comprises a display screen and wherein the cover covers the display screen when the cover is in a closed position.

12. The computing device of claim 10, wherein the keyboard further comprises keys on a top side of the keyboard, wherein the keys are adjacent to the indentation and hidden from view when the keyboard is in the closed position.

13. The computing device of claim 10, wherein the keyboard is rotatably attached to the cover via a hinge.

14. The computing device of claim 10, wherein the keyboard is rotatable between the closed position and an open position, wherein in the open position an edge of the keyboard is disposed adjacent to a top side of the case.

15. The computing device of claim 12, wherein the keys are exposed to view when the keyboard is in the open position.

16. A computing device comprising:
a case;
a first portion of a keyboard attached to the case; and
a second portion of the keyboard rotatably attached to the first portion of the keyboard.

17. The computing device of claim 16, wherein the first portion of the keyboard includes a first plurality of keys, and the second portion of the keyboard includes a second plurality of keys.

18. The computing device of claim 17, wherein the second portion of the keyboard rotates with respect to the first portion of the keyboard from a closed position to an open position.

19. The computing device of claim 18, wherein the first plurality of keys are disposed adjacent to the second plurality of keys in the closed position.

20. The computing device of claim 16, wherein the first portion of a keyboard is attached in a fixed position with respect to the case.
